(19) United States
(12) Patent Application Publication
(10) Pub. No.: US 2024/0376019 A1
(43) Pub. Date: Nov. 14, 2024

(54) CERAMIC PRODUCT

(71) Applicant: NORITAKE CO., LIMITED, Nagoya-shi, Aichi (JP)

(72) Inventors: Yukiko Kikugawa, Nagoya-shi, Aichi-ken (JP); Yoshihide Maeno, Nagoya-shi, Aichi-ken (JP); Yoshihiro Suzuki, Nagoya-shi, Aichi-ken (JP)

(21) Appl. No.: 18/687,724

(22) PCT Filed: Jul. 27, 2022
(86) PCT No.: PCT/JP2022/028996

§ 371 Date: Feb. 28, 2024

(30) Foreign Application Priority Data
Aug. 30, 2021 (JP) 2021-140391

(51) Int. Cl. C04B 41/88; C04B 41/50; C04B 41/51; C04B 41/87

(52) U.S. Cl. CPC C04B 41/88; C04B 41/5041; C04B 41/5042; C04B 41/5045; C04B 41/5111; C04B 41/87

(57) ABSTRACT

A ceramic product can include a decorative film containing noble metal elements and matrix-forming elements. The matrix-forming elements of such a ceramic product can include at least a rare earth element. Thus, in the ceramic product disclosed here, the mass concentration C_{N} of the noble metal elements obtained in FESEM-EDS analysis of the surface of the decorative film can be 11% or more and 70% or less, and the ratio (C_{R}/C_{N}) of the mass concentration C_{R} of the rare earth elements to the mass concentration C_{N} of the noble metal elements can be 0.01 or more and 0.18 or less. Since the decorative film of such a ceramic product can have both alkali resistance and acid resistance at a high level, the ceramic product can have sufficient chemical resistance and can prevent the decorative film from being damaged during washing.

### TECHNICAL FIELD

The present invention relates to a ceramic product. Specifically, the present invention relates to a ceramic product including a decorative film containing noble metal elements and matrix-forming elements. Here, priority is claimed on Japanese Patent Application No. 2021-140391, filed Aug. 30, 2021, the content of which is incorporated herein by reference.

### BACKGROUND ART

In order to impart an elegant or luxurious impression, a decorative film containing noble metal elements is sometimes formed on the surface of ceramic products such as ceramicware, glassware, and enamelware. This type of decorative film is formed by applying a decorative composition containing a predetermined component to the surface of the ceramic product and then performing a firing treatment. As an example of such a decorative composition, a metal resinate (metal organic compound) containing noble metal elements and matrix-forming elements may be exemplified. When such a decorative composition is fired, a decorative film including an amorphous region and a noble metal region is formed. In the amorphous region, an amorphous matrix (typically a glass matrix) having a framework of an oxide of predetermined metal elements and semi-metal elements (matrix-forming elements) is formed.

Some ceramic products of this type are expected to be heated in a microwave oven (for example, tableware, etc.). When the decorative film of the ceramic product contains a large amount of noble metals, there is a risk of sparks occurring due to high frequency electromagnetic waves (for example, a frequency of about 2.45 GHz) and the decorative film being damaged. Therefore, in recent years, microwaveable ceramic products in which the content of the noble metal in the decorative film is reduced have been proposed. Patent Literature 1 discloses an example of a decorative composition (over-glaze paste) for forming this type of decorative film. In the over-glaze paste described in Patent Literature 1, the content of noble metal powder is adjusted to 20 wt % or more and less than 50 wt %, and the particle size of the noble metal powder is adjusted to 0.4 μm or more and 2 μm or less. When such an over-glaze paste is fired, a noble metal layer dispersed in a polka dot pattern is formed on the surface of an insulating component (substrate).

### CITATION LIST

### Patent Literature

Patent Literature 1: Japanese Patent No. 4757434

### Non Patent Literature

Non Patent Literature 1: “Research on rare earth silicate glass” National Institute for Research in Inorganic Materials, Research report No. 42, Science and Technology Agency (1985)

### SUMMARY OF INVENTION

### Technical Problem

Incidentally, in recent years, it has been desired to develop a technique that can suitably prevent damage (peeling, cracking, etc.) to the decorative film when the ceramic product is washed. Specifically, since the amorphous region of the decorative film has poor chemical resistance, it may be damaged when washed (for example, washed using an automatic dishwasher) in a high temperature environment in which a strong alkaline detergent is used or when immersed in an acidic detergent for a long time. Particularly, the decorative film of the microwaveable ceramic product has lost the continuity of the noble metal region, the amorphous region is more likely to be exposed, and thus damage during the above washing is more likely to occur.

In order to solve the above problem, the inventors examined incorporating a rare earth element into the amorphous region of the decorative film. Specifically, it is known that, when rare earth elements are present in the amorphous matrix, it is possible to improve the alkali resistance of amorphous materials such as glass (refer to Non Patent Literature 1). This alkali resistance improvement effect is thought to be caused by doping rare earth elements having a high affinity for oxygen into the amorphous matrix, thereby tightening the mesh structure, and preventing alkali ions from entering. In addition, since rare earth oxides remain and form a coating after other components are eluted by exposure to alkaline chemicals, they are thought to have the effect of preventing alkaline erosion. However, in the ceramic product having the above structure, even though the amorphous region contains rare earth elements, a decorative film having sufficient alkali resistance cannot be formed in some cases.

The present invention has been made in view of the above circumstances, and an object of the present invention is to provide a ceramic product that has sufficient chemical resistance and can prevent damage to a decorative film during washing.

### Solution to Problem

The inventors conducted various studies in order to solve the above problems, and as a result, they found that, since the ceramic product including a decorative film having the above structure contains noble metal elements, the alkali resistance tends to decrease more easily than it does with general amorphous materials. Specifically, noble metal elements are added to the decorative film of the ceramic product in order to exhibit excellent aesthetic properties. However, since this type of noble metal element has a strong catalytic effect, a decrease in alkali resistance may be accelerated due to hydrolysis of the amorphous matrix. On the other hand, a decorative film in which a large amount of rare earth elements is added to compensate for the alkali resistance decreased by the noble metal element may have significantly reduced acid resistance. That is, it is understood that, in order to improve the overall chemical resistance of the decorative film of the ceramic product, it is necessary to appropriately control the ratio (C_{R}/C_{N}) of the mass concentration C_{R} of rare earth elements to the mass concentration C_{N} of the noble metal elements.

The technology disclosed here is based on the above findings. The technology disclosed here provides a ceramic product including a decorative film containing noble metal elements and matrix-forming elements. The matrix-forming elements of such a ceramic product include at least a rare earth element. Here, in the ceramic product disclosed here, the mass concentration C_{N} of the noble metal elements obtained in FESEM-EDS analysis of the surface of the decorative film is 11% or more and 70% or less, and the ratio (C_{R}/C_{N}) of the mass concentration C_{R} of the rare earth elements to the mass concentration C_{N} of the noble metal elements is 0.01 or more and 0.18 or less.

In the ceramic product disclosed here, in FESEM-EDS analysis of the surface of the decorative film, ratio (C_{R}/C_{N}) of the mass concentration C_{R} of the rare earth elements to the mass concentration C_{N} of the noble metal elements is 0.01 or more. Therefore, there is a certain amount or more of rare earth elements, which are a factor in improving alkali resistance, with respect to noble metal elements, which are a factor in reducing alkali resistance, and thus the alkali resistance of the decorative film can be maintained within an appropriate range. On the other hand, in the ceramic product disclosed here, the upper limit value of the above C_{R}/C_{N} is 0.18 or less. Therefore, it is possible to prevent a decrease in acid resistance due the presence of a large amount of rare earth elements.

Here, as a result of experiments conducted by the inventors, it has been found that, when the mass concentration C_{N} of the noble metal elements in FESEM-EDS analysis of the surface of the decorative film becomes too low, the chemical resistance (particularly acid resistance) of the decorative film actually decreases. On the other hand, it has been confirmed that, when the mass concentration C_{N} of the noble metal elements becomes too large, the gloss of the decorative film is significantly reduced and aesthetic properties of the ceramic product are impaired. Considering these points, in the ceramic product disclosed here, the mass concentration C_{N} of the noble metal elements in FESEM-EDS analysis of the surface of the decorative film is controlled to be 11% or more and 70% or less.

Here, in this specification, the “mass concentration” is a relative mass of any metal element (or semi-metal element) based on 100% of “a total mass of metal elements and semi-metal elements” obtained by performing FESEM-EDS (field emission scanning electron microscope-energy dispersive X-ray analysis) on the surface of the decorative film. The procedure of measuring such a “mass concentration” as follows. First, the surface (typically a flat surface) of the decorative film is observed using a field emission scanning electron microscope (FESEM) including an energy dispersive X-ray analysis (EDS) device. Then, an observation position is adjusted so that the decorative film is visible in the entire field of view at a magnification of 5,000×(field of view: 25.5 μm×19.2 μm), and a qualitative analysis chart of the metal elements and semi-metal elements is then acquired using the EDS device. Then, in the acquired qualitative analysis chart, metal elements and semi-metal elements are specified, and the relative concentration of a desired element is calculated based on a predetermined quantitative correction method (for example, standard-less correction). Therefore, the mass concentration of the desired element can be obtained. Here, in FESEM-EDS analysis of the surface of the decorative film, since elements positioned at a depth of about several hundreds of nm to 1,000 nm from the surface of the decorative film are detected, constituent elements of the layer (substrate or coat layer) positioned blow the decorative film may be reflected in the measurement results. That is, in this specification, the “mass concentration” does not mean a “mass concentration of an arbitrary element contained in the decorative film” but means a “mass concentration of an arbitrary element detected in FESEM-EDS analysis of the surface of the decorative film.” Here, the inventors confirmed by an experiment that, in FESEM-EDS analysis of the surface of the decorative film, when the mass concentration of a predetermined element satisfies the above conditions, it is possible to obtain a ceramic product that has sufficient chemical resistance and can prevent damage to a decorative film during washing.

In one preferable aspect of the ceramic product disclosed here, the matrix-forming elements further include at least one of first elements including Zr, Ti and Co. These first elements can contribute to improving chemical resistance of the decorative film.

In addition, in an aspect in which the decorative film contains the first element, the ratio (C₁/C_{R}) of the mass concentration C₁ of the first element to the mass concentration C_{R} of the rare earth elements obtained in FESEM-EDS analysis of the surface of the decorative film is preferably 3 or less. As described above, the first element can contribute to improving chemical resistance of the decorative film. However, when the mass concentration C₁ of the first element becomes too large, the mass concentration C_{R} of rare earth elements becomes insufficient, which may actually reduce the alkali resistance. In consideration of this, in this aspect, the upper limit value of the above C₁/C_{R} is limited.

In one preferable aspect of the ceramic product disclosed here, the decorative film contains at least one selected from the group consisting of Pt, Au, Pd, Rh, Ir, and Ag as the noble metal elements. These noble metal elements can contribute to the formation of a decorative film with excellent aesthetic properties.

In one preferable aspect of the ceramic product disclosed here, the ratio (C_{Pt}/C_{N}) of the mass concentration C_{Pt} of Pt to the mass concentration C_{N} of the noble metal elements is 0.75 or more. Since platinum (Pt) exhibits particularly excellent color development among the above noble metal elements, it can be suitably used to form a decorative film having excellent aesthetic properties. However, since Pt has a stronger catalytic effect than other noble metal elements (for example, Au, etc.), it is particularly likely to accelerate hydrolysis of the amorphous matrix. However, in the technology disclosed here, as described above, since the ratio (C_{R}/C_{N}) of the mass concentration C_{R} of the rare earth elements to the mass concentration C_{N} of the noble metal elements is appropriately controlled, it is possible to form a decorative film with sufficient alkali resistance even when the main component of the noble metal elements is Pt.

In one preferable aspect of the ceramic product disclosed here, the decorative film contains at least one selected from the group consisting of Y, Sm, La, Ce, Pr, Nd, and Dy as the rare earth elements. When these rare earth elements are contained, it is particularly suitably possible to minimize a decrease in alkali resistance due to noble metal elements.

In one preferable aspect of the ceramic product disclosed here, the matrix-forming elements further include at least one of second elements including Si, Al, K, Na, Mg, Ca, Ga, Ba and Bi. Therefore, an appropriate amorphous matrix can be constructed for the decorative film.

In one preferable aspect of the ceramic product disclosed here, the decorative film includes a noble metal region containing a noble metal element as a main component and an amorphous region containing a matrix-forming element as a main component, and a plurality of the noble metal regions are scattered in the amorphous region. Therefore, since each noble metal region can be insulated by the amorphous region, it is possible to prevent the decorative film from being damaged by sparks when using a microwave oven. Here, since the microwaveable ceramic product having the above structure has a large amount of the exposed amorphous region, the chemical resistance of the decorative film tends to decrease. However, according to the technology disclosed here, even with this type of microwaveable ceramic product, it is possible to form a decorative film having sufficient chemical resistance.

### BRIEF DESCRIPTION OF DRAWINGS

FIG. 1 is a diagram schematically showing a cross-sectional structure of a ceramic product according to one embodiment.

FIG. 2 is an example of a histogram with a horizontal axis that represents a brightness value of a secondary electron image of a cut surface of a ceramic product and with a vertical axis that represents a count number.

### DESCRIPTION OF EMBODIMENTS

Preferable embodiments of the technology disclosed here will be described below. Here, components other than those particularly mentioned in this specification that are necessary for implementation (for example, a detailed preparation method of a decorative composition and a ceramic product production procedure) can be understood based on the technical content taught in this specification and general common general technical knowledge of those skilled in the art in the field. The content of the technology disclosed here can be implemented based on the content disclosed in this specification and common general technical knowledge in the field. Here, the notation “A to B” indicating a range in this specification means A or more and B or less. Therefore, it includes a range exceeding A but below B.

### <Ceramic Product>

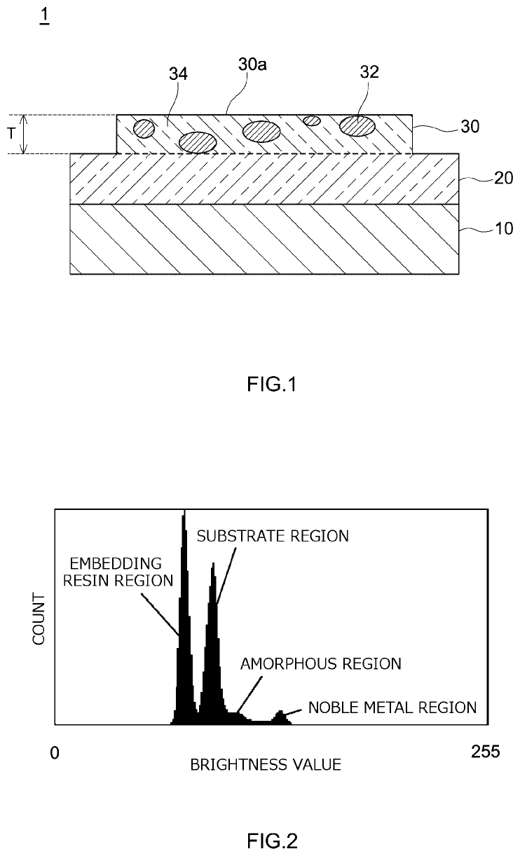

One embodiment of the ceramic product disclosed here will be described below. FIG. 1 is a diagram schematically showing a cross-sectional structure of a ceramic product according to the present embodiment. As shown in FIG. 1, a ceramic product 1 includes a substrate 10, a coat layer 20, and a decorative film 30. Respective components will be described below in detail.

### 1. Substrate

The substrate 10 is a molded product mainly composed of ceramics. Examples of ceramics for the substrate 10 include silica, alumina, zirconia, ceria, yttria, boronia, magnesia, and calcia. Here, the thickness, shape, color, hardness and the like of the substrate 10 can be appropriately changed depending on applications of the ceramic product 1, and are not intended to limit the technology disclosed here, and thus detailed description will be omitted.

### 2. Coat Layer

The coat layer 20 is a layer mainly composed of an amorphous material (typically, glass), and is formed on the surface of the substrate 10 in order to improve aesthetic properties (particularly, gloss) and protect the substrate 10. For example, the coat layer 20 is formed by applying a glaze to the surface of the substrate 10 and then firing it. Such a glaze is an agent that forms an oxide when fired and contains metal elements and semi-metal elements that form an amorphous matrix. Such a glaze may contain the same elements as the elements contained in an amorphous region 34 of the decorative film 30 or may contain different elements.

Here, the composition of the coat layer 20 is not particularly limited as long as the effects of the technology disclosed here are not significantly impaired, and conventionally known components that can be used in the protective layer of a ceramic substrate can be appropriately selected. As an example, the coat layer 20 may include Si, Al, Fe, Mg, Na, Zn, K, Ca, Sn, and the like as substantial constituent elements. Here, these constituent elements can construct an amorphous matrix in the form of an oxide. That is, in the coat layer 20, an amorphous matrix containing silicon oxide (SiO₂), aluminum oxide (Al₂O₃), iron oxide (Fe₂O₃), magnesium oxide (MgO), potassium oxide (Na₂O), zinc oxide (ZnO), potassium oxide (K₂O), calcium oxide (CaO), tin oxide (SnO₂) or the like can be constructed. Here, the abundance ratio of the above elements in the coat layer 20 does not limit the technology disclosed here, and thus detailed description will be omitted.

### 3. Decorative Film

As shown in FIG. 1, the ceramic product 1 according to the present embodiment has the decorative film 30. Such a decorative film 30 is formed on the surface of the coat layer 20. Here, although not shown, the decorative film 30 is formed to exhibit a desired pattern (including letters and pictures) in a plan view in order to improve aesthetic properties of the ceramic product 1. In addition, the decorative film 30 contains noble metal elements and matrix-forming elements, which will be described below. Typically, the decorative film 30 includes a noble metal region 32 and an amorphous region 34.

The noble metal region 32 is a region containing a noble metal element to be described below as a main component. The noble metal region 32 mainly contributes to coloring of the decorative film 30. Here, in this specification, “the noble metal region containing a noble metal element as a main component” is a region with the highest brightness at the peak of a histogram obtained by performing image analysis on a cross section of a ceramic product. In such image analysis, first, the ceramic product is cut in the thickness direction of the decorative film, and the cut surface is fixed according to a resin embedding treatment and then polished by ion milling. Next, when the sample is fixed on the sample stand with a carbon tape so that the polished surface faces upward, coating is performed using an osmium plasma coater (OPC80N, commercially available from Japan Laser Corporation), and a measurement sample whose cut surface is coated with osmium is produced. Here, the discharge voltage for osmium coating is 1.2 kV, the degree of vacuum is 6 to 8 Pa, and the coating time is 10 seconds. Next, using a field emission scanning electron microscope (SU8230, commercially available from Hitachi High-Tech Corporation), a secondary electron image of the cut surface of the decorative film is acquired. Here, the acceleration voltage for acquiring a secondary electron image is 2.0 kV, the emission current is 10±0.5 μA, and the field of view is 50,000× to 100,000×. Next, the acquired secondary electron image is subjected to noise removal by setting sigma=2 to 5 with a Gaussian filter using the image processing software image J (ver. 1.53e). In this specification, a region with a brightness value of 125 or more in the image after noise removal is regarded as a “noble metal region containing a noble metal element as a main component.” Here, when a histogram with a horizontal axis that represents the brightness value of the noise-removed image and with a vertical axis that represents the count number is created, four peaks with different brightnesses are observed (refer to FIG. 2). Here, these four peaks correspond to four regions including the embedding resin, the substrate, the amorphous region, and the noble metal region in descending order of brightness, and the region with the highest brightness corresponds to the noble metal region. The threshold value (brightness of 125 or more in FIG. 2) for determining whether it is in the noble metal region is set based on such histogram analysis.

On the other hand, the amorphous region 34 is a region that contributes to fixing and protecting of the noble metal region 32. In the amorphous region 34, an amorphous matrix is formed with a framework of an oxide of matrix-forming elements. Here, in this specification, “matrix-forming element” is a concept that includes a metal element and a semi-metal element that can construct an amorphous matrix in the form of an oxide. In addition, “amorphous matrix” refers to a structure in which an amorphous oxide (an oxide with an amorphous structure) of a predetermined metal element or semi-metal element is formed as a framework and various metal elements (or semi-metal elements) are then present in the framework as an oxide or in the form of cations. Examples of materials (amorphous materials) having such an amorphous matrix include glass. Here, in this specification, “an amorphous region containing a matrix-forming element as a main component” is a region in which the second highest brightness is confirmed in the above image analysis of a cut surface of a ceramic product.

In addition, the decorative film 30 is not limited to a layer composed of only the noble metal region 32 and the amorphous region 34 as shown in FIG. 1. For example, in the amorphous region 34, particles (crystalline particles) containing a crystalline metal oxide as a main component may be dispersed. Even when the decorative film 30 containing such crystalline particles is formed, the effects of the technology disclosed here (improvement in chemical resistance) can be appropriately exhibited.

The thickness T of the decorative film 30 is preferably 30 nm or more and 250 nm or less. The ceramic product 1 in which such a thin decorative film 30 is formed can exhibit excellent aesthetic properties at a low cost, but the decorative film 30 is very easily peeled off, and even if the decorative film 30 is slightly peeled off, the aesthetic properties may be significantly impaired. However, according to the technology disclosed here, it is possible to improve chemical resistance of the decorative film 30 and it is possible to prevent the decorative film 30 from being peeled off due to exposure to chemicals (detergents, etc.). That is, the technology disclosed here can be particularly preferably applied to the ceramic product 1 having the thin decorative film 30. Here, in this specification, as shown in FIG. 1, “the thickness T of the decorative film” is a distance from a surface 30a of the decorative film 30 to the deepest position of the noble metal region 32. As in the present embodiment, when the coat layer 20 containing an amorphous material as a main component is present between the substrate 10 and the decorative film 30, a clear boundary may not occur between the decorative film 30 (the amorphous region 34) and the coat layer 20. Therefore, in this specification, for convenience, a part of the noble metal region 32 is regarded as the decorative film 30.

Here, in the ceramic product 1 shown in FIG. 1, the plurality of noble metal regions 32 are scattered in the amorphous region 34. Therefore, since each noble metal region 32 is insulated by the amorphous region 34, it is suitably possible to prevent the occurrence of sparks when using a microwave oven. On the other hand, since this type of microwaveable ceramic product has a large amount of the exposed amorphous region, the chemical resistance of the decorative film tends to decrease. However, while the ceramic product 1 according to the present embodiment is a microwaveable ceramic product, it has the decorative film 30 having excellent chemical resistance. The composition of the decorative film 30 that achieves such excellent chemical resistance will be described below.

### (1) Noble Metal Element

The noble metal element is a component that contributes to coloring the decorative film 30. As described above, the noble metal element is a main component of the noble metal region 32. However, a position at which the noble metal element is present within the decorative film 30 is not a factor that limits the technology disclosed here. That is, depending on production conditions, some of the noble metal elements may be mixed into the amorphous region 34. Examples of noble metal elements include platinum (Pt), gold (Au), palladium (Pd), rhodium (Rh), iridium (Ir), silver (Ag), ruthenium (Ru), and osmium (Os).

Here, the ceramic product 1 according to the present embodiment has a first characteristic that the mass concentration C_{N} of the noble metal elements in FESEM-EDS analysis of the surface 30a of the decorative film 30 is controlled to be 11% or more and 70% or less. Therefore, it is possible to form the decorative film 30 that prevents a significant decrease in chemical resistance (particularly acid resistance) and has excellent aesthetic properties. Specifically, when the mass concentration C_{N} of the noble metal elements in FESEM-EDS analysis of the surface 30a of the decorative film 30 decreases, the alkali resistance is less likely to decrease due to the catalytic effect of the noble metal elements, but it is confirmed in an experiment that the acid resistance of the decorative film 30 tends to decrease. On the other hand, in the present embodiment, when the mass concentration C_{N} of the noble metal elements is 11% or more, a significant decrease in acid resistance is prevented. Here, in order to form the decorative film 30 having better acid resistance, the mass concentration C_{N} of the noble metal elements is preferably 11.5% or more, more preferably 12% or more, still more preferably 12.5% or more, and particularly preferably 13% or more. In addition, when the amount of the noble metal elements contained in the decorative film 30 decreases, aesthetic properties of the ceramic product 1 may deteriorate due to a decrease in coloring components. However, it has been confirmed that, when the mass concentration C_{N} of the noble metal elements in FESEM-EDS analysis of the surface 30a of the decorative film 30 is 11% or more, the decorative film 30 having suitable color development can be formed.

On the other hand, it has been confirmed that, when the mass concentration C_{N} of the noble metal elements becomes too large, the gloss of the decorative film 30 decreases and aesthetic properties of the ceramic product 1 are impaired. This is speculated to be because, in a decorative film in which the abundance of the noble metal elements becomes too large, the particle size of noble metal particles becomes too large due to oversintering, which causes the occurrence of fogging in the decorative film. In consideration of this, in the present embodiment, the mass concentration C_{N} of the noble metal elements is controlled to be 70% or less. Here, in order to obtain the ceramic product 1 having better aesthetic properties, the mass concentration C_{N} of the noble metal elements is preferably 69.5% or less, more preferably 69% or less, still more preferably 68.5% or less, and particularly preferably 68% or less.

Here, since platinum (Pt) exhibits particularly excellent color development among the above noble metal elements, it is suitable to form the decorative film 30 having excellent aesthetic properties. For example, the microwaveable ceramic product 1 according to the present embodiment has a problem that the decorative film 30 tends to appear dark because the continuity of the noble metal region 32 is lost. However, when Pt is used as a main component of the noble metal elements, the decorative film 30 having excellent color development can be formed even in the microwaveable ceramic product 1. On the other hand, since Pt has a stronger catalytic effect than other noble metal elements (for example, Au, etc.), it is particularly likely to accelerate a decrease in alkali resistance due to hydrolysis of the amorphous matrix. However, in the ceramic product 1 according to in the present embodiment, the ratio C_{R}/C_{N} to be described below is controlled within an appropriate range so that a decrease in alkali resistance of the decorative film 30 due to the noble metal element (Pt) can be compensated for. Therefore, according to the present embodiment, even when Pt is used as a main component of the noble metal elements, it is possible to form the decorative film 30 having sufficient alkali resistance and excellent color development. Here, in this specification, “containing Pt as a main component of the noble metal elements” means that the ratio (C_{Pt}/C_{N}) of the mass concentration C_{Pt} of Pt to the mass concentration C_{N} of the all noble metal elements confirmed in FESEM-EDS analysis of the surface of the decorative film is 0.75 or more (preferably 0.85 or more, and more preferably 0.95 or more).

### (2) Matrix-Forming Element

As described above, the matrix-forming element is a metal element or a semi-metal element that can construct an amorphous matrix in the form of an oxide. However, like the above noble metal element, the position of the matrix-forming element in the decorative film 30 does not limit the technology disclosed here. That is, depending on production conditions, some elements that can be considered as matrix-forming elements may be mixed into the noble metal region 32. Examples of matrix-forming elements include Al, Ti, Zr, Si, Bi, Sm, Y, La, Ce, Pr, Nd, Sm, Dy, Sn, Zn, Be, Mg, Ca, Sr, Ba, Li, Na, K, Rb, B, V, Fe, Cu, P, Sc, Pm, Eu, Gd, Tb, Ho, Er, Tm, Yb, Lu, Ni, In, Co, and Cr. Here, among the above noble metal elements, there are some elements (Ag, etc.) that partially oxidize during the firing treatment and constitute an amorphous matrix. However, in this specification, for convenience, elements listed as the above (1) noble metal elements are not regarded as matrix-forming elements. That is, in this specification, “the mass concentration C_{M} of the matrix-forming elements” is a mass concentration of the elements excluding noble metal elements, among metal elements and semi-metal elements that can form an amorphous matrix.

Although the technology disclosed here is not limited, the mass concentration C_{M} of the matrix-forming elements in FESEM-EDS analysis of the surface 30a of the decorative film 30 is preferably 20% or more, more preferably 22.5% or more, still more preferably 25% or more, and particularly preferably 27.5% or more. Therefore, it is possible to form the decorative film 30 including a sufficient amorphous region 34 and exhibiting excellent gloss. On the other hand, the mass concentration C_{M} of the matrix-forming elements is preferably 50% or less, more preferably 47.5% or less, and particularly preferably 45% or less. Therefore, it is possible to secure a certain amount or more of the noble metal region 32 and to form the decorative film 30 having excellent color development.

Next, elements that can be contained in the decorative film 30 as matrix-forming elements will be described in detail.

### (a) Rare Earth Element

First, the decorative film 30 in the present embodiment includes at least a rare earth element as a matrix-forming element. The rare earth element can be selected from among scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu) without particular limitations. Since these rare earth elements have a high affinity for oxygen, they can be doped into an amorphous matrix to tighten the mesh structure. In addition, the rare earth oxide remains and forms a coating even after other components are eluted by exposure to alkaline chemicals. Therefore, this can prevent an alkali from entering the amorphous region 34 and the decorative film 30 from being damaged. Here, among the above rare earth elements, Y, Sm, La, Ce, Pr, Nd, and Dy can appropriately improve the alkali resistance of the decorative film 30. Particularly, relatively small amounts of Sm, La, Ce, Pr, Nd, and Dy can sufficiently improve alkali resistance.

Here, the ceramic product 1 according to the present embodiment has a second characteristic that, in FESEM-EDS analysis of the surface 30a of the decorative film 30, the ratio (C_{R}/C_{N}) of the mass concentration C_{R} of the rare earth elements to the mass concentration C_{N} of the noble metal elements is 0.01 or more and 0.18 or less. First, the decorative film 30 having a C_{R}/C_{N} of 0.01 or more contains a certain amount or more of rare earth elements, which are a factor in improving alkali resistance, with respect to noble metal elements, which are a factor in reducing alkali resistance, and thus the alkali resistance can be maintained within an appropriate range. Here, in order to realize the decorative film 30 having better alkali resistance, the above C_{R}/C_{N} is preferably 0.012 or more, more preferably 0.014 or more, still more preferably 0.016 or more, and particularly preferably 0.018 or more. On the other hand, the decorative film 30 containing an excessive amount of rare earth elements may have significantly reduced acid resistance. In consideration of such a decrease in acid resistance, the upper limit value of the ceramic product 1 according to in the present embodiment, the above C_{R}/C_{N} is determined to be 0.18 or less. Here, in order to realize the decorative film 30 having better acid resistance, the above C_{R}/C_{N} is preferably 0.17 or less, more preferably 0.16 or less, and still more preferably 0.15 or less. Here, in the technology disclosed here, it is sufficient for the mass concentration C_{N} of the noble metal elements to be 11% or more and 70% or less and the above C_{R}/C_{N} to be 0.01 or more and 0.18 or less, and the mass concentration C_{R} itself of rare earth elements is not particularly limited. For example, the mass concentration C_{R} of rare earth elements in FESEM-EDS analysis of the surface 30a of the decorative film 30 may be 0.3% or more, 0.4% or more, or 0.5% or more. On the other hand, the upper limit value of the mass concentration C_{R} of the rare earth elements may be 7.5% or less, 6.0% or less, or 5.5% or less.

### (b) First Element

In addition, the decorative film 30 preferably contains at least one of first elements including zirconium (Zr), titanium (Ti) and cobalt (Co). These first elements can contribute to further improving chemical resistance of the decorative film 30. Although there is no intention to limit the technology disclosed here, the reason why such an effect is speculated as follows. First, Zr is present in an amorphous matrix in the form of zirconium oxide (ZrO₂), and Ti is present in an amorphous matrix in the form of titanium oxide (TiO₂). These ZrO₂ and TiO₂ can be combined with an amorphous matrix framework (for example, silicate glass) as ions that modify the mesh structure. Here, since ZrO₂ and TiO₂ have very high chemical resistance as individual materials, they remain and form a coating even after other components are eluted by exposure to alkaline chemicals, and contribute to improve chemical resistance of the decorative film 30. On the other hand, Co is present in an amorphous matrix in the form of cobalt oxide (at least one of CoO, Co₃O₄, and Co₂O₃). This cobalt oxide can also be combined with an amorphous matrix framework as ions that modify the mesh structure. Here, cobalt oxide can contribute to improving chemical resistance of the decorative film 30 by strengthening the adhesion between the noble metal region 32 and the amorphous region 34.

However, in FESEM-EDS analysis of the surface 30a of the decorative film 30, when the mass concentration C₁ of the first element becomes too large, since the mass concentration C_{R} of rare earth elements relatively decreases, it may become difficult to form the decorative film 30 having excellent alkali resistance that satisfies the above C_{R}/C_{N} condition. In consideration of this, the ratio (C₁/C_{R}) of the mass concentration C₁ of the first element to the mass concentration C_{R} of the rare earth elements is preferably 3 or less, more preferably 2.9 or less, still more preferably 2.8 or less, and particularly preferably 2.7 or less. On the other hand, the decorative film 30 in the present embodiment can exhibit a certain level or more of chemical resistance even if it does not contain the first element, as long as it satisfies the above C_{R}/C_{N} condition. Therefore, the lower limit value of the above C₁/C_{R} is not particularly limited, and C₁/C_{R} may be 0. However, in order to appropriately exhibit the chemical resistance improvement effect of the first element, it is preferable to contain the first element so that C₁/C_{R} is 0.1 or more (more preferably 0.2 or more, still more preferably 0.3 or more, and particularly preferably 0.4 or more).

Here, the mass concentration C₁ of the first element itself is not particularly limited. However, in order to more appropriately exhibit the chemical resistance improvement effect of the first element, the mass concentration C₁ of the first element is preferably 0.01% or more, more preferably 0.02% or more, and particularly preferably 0.03% or more. On the other hand, in order to prevent a relative decrease in the mass concentration C_{R} of rare earth elements due to excessive addition of the first element, the mass concentration C₁ of the first element is preferably 5% or less, more preferably 4% or less, still more preferably 3% or less, and particularly preferably 2% or less.

### (c) Second Element

Next, the matrix-forming elements may include a rare earth element and a metal element or semi-metal element other than the first element as long as an appropriate amorphous matrix can be formed in the amorphous region 34. In this specification, such rare earth elements and matrix-forming elements other than the first element are referred to as “second element.” Hereinafter, Si, Al, and Bi will be described as examples of such second elements.

First, Si can constitute an amorphous matrix framework of the amorphous region 34 in the form of silicon oxide (SiO₂). Here, although the technology disclosed here is not limited, in FESEM-EDS analysis of the surface 30a of the decorative film 30, the Si mass concentration C_{Si} is preferably 10% or more, more preferably 15% or more, still more preferably 17.5% or more, and particularly preferably 20% or more. Therefore, it is possible to form a strong amorphous matrix having an appropriate framework. On the other hand, in order to secure sufficient other elements (rare earth elements, first elements, etc.), the upper limit of the Si mass concentration C_{Si} is preferably 60% or less, more preferably 59.5% or less, still more preferably 59% or less, and particularly preferably 58.5% or less.

Next, some Al forms a composite oxide with other elements (Si, rare earth elements, etc.) and can contribute to improving chemical resistance of the decorative film 30. Although the technology disclosed here is not limited, in order to obtain the decorative film 30 having better chemical resistance, in FESEM-EDS analysis of the surface 30a of the decorative film 30, the Al mass concentration C_{Al} is preferably 1% or more, more preferably 1.5% or more, still more preferably 2% or more, and particularly preferably 2.5% or more. On the other hand, in order to secure a sufficient abundance of rare earth elements, first elements and the like, the upper limit of the Al mass concentration C_{Al} is preferably 15% or less, more preferably 14% or less, still more preferably 13.5% or less, and particularly preferably 13% or less.

In addition, Bi forms a part of the amorphous matrix framework of the amorphous region 34 in the form of bismuth oxide (Bi₂O₃). Since such Bi₂O₃ has an effect of softening the amorphous material, it can contribute to improving fixability of the decorative film 30 in the ceramic product 1. Particularly, as in the present embodiment, when the decorative film 30 is formed on the surface of the coat layer 20, even better fixability can be obtained by diffusing Bi₂O₃ toward the coat layer 20. Bi can contribute to preventing the decorative film 30 from being peeled off by improving such fixability. Here, in order to more preferably exhibit the fixing property improvement effect of Bi, in FESEM-EDS analysis of the surface 30a of the decorative film 30, the Bi mass concentration C_{Bi} is preferably 0.01% or more, more preferably 0.015% or more, and particularly preferably 0.05% or more. On the other hand, in order to secure a sufficient abundance of rare earth elements, first elements and the like, the Bi mass concentration C_{Bi} is preferably 5% or less, more preferably 4.7% or less, still more preferably 4.5% or less, and particularly preferably 4% or less.

Here, the above description is not intended to limit the second element to Si, Al, and Bi. A detailed description will be omitted because the influence on the effects of the technology disclosed here is small, and examples of second elements other than Si, Al, and Bi include Sn, Zn, Be, Mg, Ca, Sr, Ba, Li, Na, K, Rb, B, V, Fe, Cu, P, Ni, Cr and the like. Here, in FESEM-EDS analysis of the surface 30a of the decorative film 30, the mass concentration C₂ of the second element is preferably 88% or less, more preferably 80% or less, still more preferably 75% or less, and particularly preferably 70% or less. Therefore, this can prevent a relative decrease in the mass concentration of elements (rare earth elements, first elements, etc.) that do not significantly affect the chemical resistance of the decorative film 30. On the other hand, the lower limit value of the mass concentration C₂ of the second element is not particularly limited, and may be 20% or more, 25% or more, or 30% or more.

### (3) Non-Metal Element

In addition, the decorative film 30 of the ceramic product 1 according to the present embodiment may contain non-metal elements in addition to the noble metal elements and metal elements that are matrix-forming elements. For example, as described above, since the matrix-forming element is present in the amorphous region 34 in the form of an oxide, oxygen (O) may be present in the decorative film 30. In addition, although details will be described below, various organic materials are added to the decorative composition (paint) that is a precursor of the decorative film 30. The fired decorative film 30 may contain non-metal elements derived from such organic materials. Examples of this type of non-metal element include carbon (C), sulfur(S), nitrogen (N), and phosphorus (P).

### <Method of Producing Ceramic Product>

Next, an example of a method of producing the ceramic product 1 according to the present embodiment will be described. Here, the ceramic product disclosed here is not limited to those produced by the following production method.

When the ceramic product 1 according to the present embodiment is produced, first, the desired substrate 10 is prepared. For example, the substrate 10 can be produced by molding and firing a substrate material obtained by kneading a predetermined ceramic component. In addition, the substrate 10 with the coat layer 20 shown in FIG. 1 can be produced by applying a glaze to the surface of the fired substrate 10 and then firing it again. However, this process is not particularly limited as long as the substrate 10 can be prepared. For example, a separately produced substrate 10 may be purchased and prepared.

Next, when the ceramic product 1 according to the present embodiment is produced, the decorative film 30 is formed on the substrate 10. When the decorative film 30 is formed, a desired pattern is drawn on the surface of the substrate 10 using a decorative composition (paint) containing predetermined components and a firing treatment is then performed. In the firing treatment in this process, the firing temperature is preferably set to be within a range of 700° C. to 1,000° C. Therefore, the decorative film 30 can be formed by appropriately sintering the components of the decorative composition.

The decorative composition used in the present embodiment is a paste-like composition containing noble metal elements and matrix-forming elements. Here, the forms of the noble metal elements and the matrix-forming elements in the decorative composition are not particularly limited. For example, the noble metal elements and the matrix-forming elements may have the form of a metal resinate, a complex, a polymer, a solid component (fine particles) or the like. Here, details of the noble metal elements and the matrix-forming elements contained in the decorative composition will be omitted because explanations are redundant.

Here, when the firing treatment in this process is performed, the decorative composition and some components of the underlying layer (the substrate 10 or the coat layer 20) coated with the decorative composition may be mixed. Therefore, the decorative film 30 after the firing treatment includes not only elements derived from the decorative composition but also elements derived from the underlying layer. In addition, the degree to which the components of the underlying layer are mixed into the decorative film may vary depending on not only the decorative composition and the components of the underlying layer but also firing conditions (the firing temperature, the firing time, etc.). Therefore, when the ceramic product disclosed here is produced, it is preferable to appropriately change various conditions such as the formulation of the decorative composition, the composition of the underlying layer, and firing conditions and to appropriately perform a preliminary test in order to examine conditions in which a ceramic product with a desired structure is formed.

In addition, in the decorative composition, in addition to the noble metal elements and the matrix-forming elements, it is preferable to add various components in consideration of fixability to the surface of the substrate, moldability and the like. As such additives, conventionally known components that can be used in the decorative composition can be used without particular limitations as long as the effects of the technology disclosed here are not significantly impaired. For example, when each of the noble metal elements and the matrix-forming elements is contained in the form of a metal resinate, an organic compound for forming the metal resinate is added to the decorative composition. As such an organic compound, conventionally known resin materials that can be used to produce the metal resinate can be used without particular limitations. Examples of such resin materials include carboxylic acids with a large number of carbon atoms (for example, 8 or more carbon atoms) such as octylic acid (2-ethylhexanoic acid), abietic acid, naphthenic acid, stearic acid, oleic acid, linolenic acid, and neodecanoic acid; sulfonic acid; resin acids contained in rosin or the like; resin sulfurized balsam containing an essential oil component such as turpentine oil and lavender oil, alkyl mercaptide (alkyl thiolate), aryl mercaptide (aryl thiolate), mercaptocarboxylic acid ester, and alkoxide.

In addition, when each of the noble metal elements and the matrix-forming elements is contained in the form of a metal resinate, it is preferable to use an organic solvent in which the metal resinate is dispersed or dissolved. As such a solvent, those conventionally used in resinate pastes and those used in gold liquids can be used without particular limitations. Examples thereof include 1,4-dioxane, 1,8-cineole, 2-pyrrolidone, 2-phenylethanol, N-methyl-2-pyrrolidone, p-tolualdehyde, benzyl benzoate, butyl benzoate, eugenol, caprolactone, geraniol, methyl salicylate, cyclohexanone, cyclohexanol, cyclopentyl methyl ether, citronellal, di(2-chloroethyl) ether, diethylene glycol monomethyl ether, diethylene glycol monobutyl ether, dihydrocarbon, dibromomethane, dimethyl sulfoxide, dimethylformamide, nitrobenzene, pyrrolidone, propylene glycol monophenyl ether, pulegone, benzyl acetate, benzyl alcohol, benzaldehyde, turpentine oil, and lavender oil. Here, these organic solvents may be used one or two or more thereof may be used. Here, since the metal resinate is commercially available as, for example, a resinate paste, such a resinate paste may be used without change.

In addition, the decorative composition may contain other additional components as long as the effects of the technology disclosed here are not significantly impaired. Examples of such additional components include an organic binder, a protective material, a surfactant, a thickener, a pH adjuster, a preservative, an antifoaming agent, a plasticizer, a stabilizer, and an antioxidant.

### OTHER EMBODIMENTS

One embodiment of the technology disclosed here has been described above. Here, the ceramic product 1 according to the above embodiment is an example in which the technology disclosed here is applied and does not limit the technology disclosed here.

For example, as shown in FIG. 1, the ceramic product 1 according to the above embodiment has the coat layer 20 between the substrate 10 and the decorative film 30. However, in the ceramic product disclosed here, the coat layer 20 is not an essential structure. That is, the decorative film may be formed directly on the surface of the ceramic substrate. According to the technology disclosed here, also in the ceramic product in which a decorative film is directly formed on the surface of the substrate, a decorative film having sufficient chemical resistance can be formed. In addition, other examples of ceramic products include those in which a mat layer in which predetermined metal oxide particles (for example zircon particles) are dispersed is formed between a substrate and a decorative film and the gloss of the decorative film is intentionally reduced. In addition, other examples of ceramic products include those in which a paint layer is formed between a substrate and a coat layer to form a 3D decorative film. The technology disclosed here can be applied to ceramic products with these structures without particular limitations.

In addition, as shown in FIG. 1, the ceramic product 1 according to the above embodiment is a microwaveable ceramic product in which the plurality of noble metal regions 32 are scattered in the amorphous region 34. However, also in the ceramic product other than microwaveables, the technology disclosed here can contribute to realizing the decorative film having excellent chemical resistance. However, in the microwaveable ceramic product 1 shown in FIG. 1, since the exposed amount of the amorphous region 32 is very large, the phenomenon of acceleration of hydrolysis of the amorphous matrix due to the catalytic effect of the noble metal elements tends to realize in the form of a significant decrease in alkali resistance of the decorative film 30. The technology disclosed here can appropriately prevent a decrease in alkali resistance caused by the noble metal element, and thus can be particularly preferably applied to microwaveable ceramic products.

### TEST EXAMPLES

Test examples related to the technology disclosed here will be described below, but the technology disclosed here is not intended to be limited to such test examples.

### A. First Test

In this test, ceramic products (Example 1 to Example 23) produced using 23 types of decorative compositions having different formulations were prepared, and the performance (acid resistance, alkali resistance, and gloss of the decorative film) of the ceramic products of respective examples were examined.

### 1. Preparation of Sample

### <Production of Ceramic Product>

In this test, first, a white porcelain plate (length: 15 mm, width: 15 mm) with a coat layer was prepared. Then, a decorative composition containing noble metal elements and matrix-forming elements was applied to the entire surface of one side of the white porcelain plate. The decorative composition was applied using a spin coater (Opticoat MS-A-150, commercially available from Mikasa Corporation), and spin conditions were adjusted so that the film thickness of the decorative film after firing was within a range of 30 nm to 250 nm. Then, the white porcelain plate coated with the decorative composition was dried on a hot plate at 60° C. for 1 hour and then fired at 800° C. for 10 minutes. Thereby, the ceramic product in which the decorative film was formed on the surface was produced. Here, the coat layer formed on the white porcelain plate was obtained by firing a glaze having the following composition at 1,200° C.

### [Composition of Glaze for Forming Coat Layer]

SiO₂: 70.8 wt %
Al₂O₃: 16.39 wt %
Fe₂O₃: 0.11 wt %
CaO: 4.2 wt %
MgO: 3.99 wt %
K₂O: 3.36 wt %
Na₂O: 0.63 wt %
ZnO: 0.53 wt %

Then, in this test, in each of Example 1 to Example 23, formations of paints (decorative compositions) for forming a decorative film were different. Here, when the decorative composition was prepared, various raw materials were mixed in an ointment pot, and mixed using a stirrer (product name: Rotation and Revolution Thinky Mixer, commercially available from Thinky Corporation) at a rotational speed of 1,800 rpm for 2 minutes. Then, each decorative composition was appropriately diluted so that the viscosity was in a range of 10 mPa·s to 15 mPa·s. Table 1 shows formulations of the decorative compositions used in Example 1 to Example 23. Here, each element shown in Table 1 was added to the decorative composition in the following form.

### [Form of Each Element in Decorative Composition]

Ag: Ag resinate (silver resinate)
Au: Au resinate (gold resin sulfurized balsam)
Pt: Pt resinate (platinum resin sulfurized balsam)
Rh: Rh resinate (rhodium resin sulfurized balsam)
Al: Al resinate (aluminum resinate) and aluminum complex
Ti: Ti resinate (titanium resinate) and titanium complex
Co: Co resinate (cobalt resinate)
Si: Si resinate (silicon resinate)
Bi: Bi resinate (bismuth resinate)
Sm: Sm resinate (samarium resinate)
Y: Y resinate (yttrium resinate)
La: La resinate (lanthanum resinate)
Ce: Ce resinate (cerium resinate)
Pr: Pr resinate (praseodymium resinate)
Nd: Nd resinate (neodymium resinate)
Dy: Dy resinate (dysprosium resinate)

TABLE 1

| | Noble metal element | | | Rare earth element | | | | | | | First element | | Second element | | |
|---|---|---|---|---|---|---|---|---|---|---|---|---|---|---|---|
| | Pt | Au | Rh | Y | La | Ce | Pr | Nd | Sm | Dy | Ti | Co | Al | Si | Bi |
| Example 1 | 81.99 | | 0.68 | | | | | | 4.55 | | | | 0.68 | 6.40 | 5.70 |
| Example 2 | 87.88 | | 0.50 | 3.15 | | | | | | | | | 0.05 | 4.42 | 3.99 |
| Example 3 | 59.66 | 1.84 | 1.15 | | | | | | 3.42 | | 1.12 | 8.95 | | 17.43 | 6.43 |
| Example 4 | 84.03 | | 0.48 | | | | | 2.34 | | | | | 0.69 | 6.56 | 5.91 |
| Example 5 | 84.03 | | 0.48 | | | | 2.34 | | | | | | 0.69 | 6.56 | 5.91 |
| Example 6 | 79.48 | | 0.44 | | | | | | 7.49 | | 0.68 | | 0.13 | 6.13 | 5.65 |
| Example 7 | 69.15 | 17.29 | 0.49 | | | | | | 3.28 | | | | 3.16 | 1.36 | 5.27 |
| Example 8 | 82.10 | | 0.67 | | | | | | 4.37 | | | | 0.67 | 6.41 | 5.78 |
| Example 9 | 69.02 | | 0.40 | | | | | | 11.42 | | 1.06 | | 0.20 | 9.37 | 8.54 |
| Example 10 | 83.66 | | 0.48 | | 2.76 | | | | | | | | 0.69 | 6.53 | 5.89 |
| Example 11 | 79.48 | | 0.44 | | | | | | 7.49 | | 0.68 | | 0.13 | 6.13 | 5.65 |
| Example 12 | 79.48 | | 0.44 | | | | | | 7.49 | | 0.68 | | 0.13 | 6.13 | 5.65 |
| Example 13 | 79.48 | | 0.44 | | | | | | 7.49 | | 0.68 | | 0.13 | 6.13 | 5.65 |
| Example 14 | 79.48 | | 0.44 | | | | | | 7.49 | | 0.68 | | 0.13 | 6.13 | 5.65 |
| Example 15 | 79.48 | | 0.44 | | | | | | 7.49 | | 0.68 | | 0.13 | 6.13 | 5.65 |
| Example 16 | 84.03 | | 0.48 | | | | | | | 2.34 | | | 0.69 | 6.56 | 5.91 |
| Example 17 | 84.03 | | 0.48 | | | 2.34 | | | | | | | 0.69 | 6.56 | 5.91 |
| Example 18 | 79.48 | | 0.44 | | | | | | 7.49 | | 0.68 | | 0.13 | 6.13 | 5.65 |
| Example 19 | 77.10 | | 0.44 | | | | | | 17.84 | | | | 0.83 | 1.56 | 2.23 |
| Example 20 | 79.48 | | 0.44 | | | | | | 7.49 | | 0.68 | | 0.13 | 6.13 | 5.65 |
| Example 21 | 79.48 | | 0.44 | | | | | | 7.49 | | 0.68 | | 0.13 | 6.13 | 5.65 |
| Example 22 | 86.04 | | 0.49 | | | | | | | | | | 0.70 | 6.71 | 6.05 |
| Example 23 | 85.61 | | | | | | | | 1.17 | | | | 0.69 | 6.59 | 5.94 |

### 2. Evaluation Test

### <Measurement of Mass Concentration>

Test pieces cut out from ceramic products of Example 1 to Example 23 were fixed on a sample stand with a carbon tape so that the decorative film faced upward, and coated using an osmium plasma coater (OPC80N, commercially available from Japan Laser Corporation). Therefore, a measurement sample in which the surface of the decorative film was coated with osmium was produced. Here, the discharge voltage during coating was 1.2 kV, the degree of vacuum was 6 to 8 Pa, and the coating time was 10 seconds.

Next, using a field emission scanning electron microscope (SU8230, commercially available from Hitachi High-Tech Corporation) and an energy dispersive X-ray analyzer (detector: X-Max80, software: EMAX ENERGY version 2.04, commercially available from HORIBA, Ltd.), a qualitative analysis chart of elements on the surface of the decorative films of the measurement samples of respective examples was acquired. Here, in this test, K rays were used in the analysis of C, O, Na, Mg, Al, Si, K, Ca, Ti, Zn, Ga, and Co. In addition, L rays were used in the analysis of Ba, Y, La, Ce, Pr, Nd, Sm, Dy, Pt, Au, and Rh, and M rays were used in the analysis of Bi. Thus, based on such a qualitative analysis chart, the mass concentration of each element was measured. Here, the mass concentration of each element was calculated by designating only metal elements and semi-metal elements as target elements in the mode “quantitative analysis” in EMAX software and performing automatic computation (standard-less correction). In addition, detailed measurement conditions in the above FESEM-EDS analysis are as follows.

### [Detection Conditions]

Field of view: 5,000×
Pressurized voltage: 15.0 kV
Emission current: 10 μA
Extracting voltage: 4.2 kV
Probe current setting: High
Condenser lens 1:4.0
Working distance: 15.0±0.5 mm

### [Qualitative Analysis Conditions]

Spectrum collection time: 60 seconds
Process time: 4
Spectrum range: 0-20 keV
Number of channels: 2 k

Here, in this test, based on the qualitative analysis chart acquired under the above conditions, the mass concentration (%) of each element based on a total number of atoms (100%) on the surface of the decorative film was calculated. The calculation results are shown in Table 2.

TABLE 2

| | Noble metal element | | | Rare earth element | | | | | | | First element | | Second element | | | | | | |
|---|---|---|---|---|---|---|---|---|---|---|---|---|---|---|---|---|---|---|---|
| | Pt | Au | Rh | Y | La | Ce | Pr | Nd | Sm | Dy | Ti | Co | Na | Mg | Al | Si | K | Ca | Bi |
| Exam- | 41.57 | | 0.32 | | | | | | 1.76 | | | | 0.41 | 2.74 | 7.92 | 36.81 | 3.32 | 3.38 | 1.78 |
| ple 1 | | | | | | | | | | | | | | | | | | | |
| Exam- | 49.72 | | 0.24 | 3.21 | | | | | | | | | 0.46 | 2.38 | 6.77 | 31.17 | 2.67 | 2.53 | 0.84 |
| ple 2 | | | | | | | | | | | | | | | | | | | |
| Exam- | 35.23 | 1.89 | 0.59 | | | | | | 1.5 | | 0.51 | 3.56 | 0.46 | 2.47 | 7.63 | 37.89 | 3.35 | 2.86 | 2.06 |
| ple 3 | | | | | | | | | | | | | | | | | | | |
| Exam- | 51.23 | | 0.45 | | | | | 0.99 | | | | | 0.44 | 2.2 | 6.65 | 30.59 | 2.83 | 2.43 | 2.19 |
| ple 4 | | | | | | | | | | | | | | | | | | | |
| Exam- | 52.68 | | 0.33 | | | | 0.79 | | | | | | 0.45 | 1.87 | 6.1 | 30.04 | 2.63 | 2.32 | 2.78 |
| ple 5 | | | | | | | | | | | | | | | | | | | |
| Exam- | 32.78 | | 0.15 | | | | | | 2.53 | | 0.12 | | 0.52 | 2.29 | 8.57 | 44.03 | 4.35 | 3.38 | 1.29 |
| ple 6 | | | | | | | | | | | | | | | | | | | |
| Exam- | 41.66 | 10.97 | 0.57 | | | | | | 1.35 | | | | 0.34 | 2.4 | 7.66 | 27.81 | 2.55 | 2.69 | 1.98 |
| ple 7 | | | | | | | | | | | | | | | | | | | |
| Exam- | 40.24 | | 0.28 | | | | | 1.31 | | | | | 0.57 | 1.71 | 7.45 | 40.19 | 4.06 | 2.58 | 1.6 |
| ple 8 | | | | | | | | | | | | | | | | | | | |
| Exam- | 30.73 | | 0.17 | | | | | | 4.63 | | | | 0.40 | 2.93 | 8.52 | 42.4 | 3.8 | 3.4 | 2.68 |
| ple 9 | | | | | | | | | | | | | | | | | | | |
| Exam- | 48.76 | | 0.43 | | 2.52 | | | | | | | | 0.54 | 1.96 | 6.42 | 31.54 | 2.9 | 2.32 | 2.61 |
| ple 10 | | | | | | | | | | | | | | | | | | | |
| Exam- | 43.97 | | 0.44 | | | | | | 3.72 | | 0.44 | | 0.29 | 2.28 | 6.72 | 32.71 | 3.31 | 3.33 | 2.79 |
| ple 11 | | | | | | | | | | | | | | | | | | | |
| Exam- | 33.5 | | 0.03 | | | | | | 2.95 | | 0.19 | | 0.36 | 2.57 | 8.5 | 41.63 | 4.14 | 3.92 | 2.22 |
| ple 12 | | | | | | | | | | | | | | | | | | | |
| Exam- | 15.43 | | 0.34 | | | | | | 1.37 | | 0.07 | | 0.72 | 3.94 | 11.56 | 53.31 | 5.24 | 5.51 | 2.52 |
| ple 13 | | | | | | | | | | | | | | | | | | | |
| Exam- | 15.44 | | 0 | | | | | | 1.32 | | 0.08 | | 0.64 | 3.71 | 11.5 | 55.12 | 5.5 | 5.49 | 1.19 |
| ple 14 | | | | | | | | | | | | | | | | | | | |
| Exam- | 11.78 | | 0.01 | | | | | | 0.94 | | 0.06 | | 0.65 | 3.99 | 12.38 | 58.31 | 5.68 | 5.77 | 0.44 |
| ple 15 | | | | | | | | | | | | | | | | | | | |
| Exam- | 50.68 | | 0.31 | | | | | | | 2.03 | | | 0.37 | 2.38 | 6.53 | 30.05 | 2.65 | 2.62 | 2.37 |
| ple 16 | | | | | | | | | | | | | | | | | | | |
| Exam- | 66.27 | | 0.64 | | | 2.26 | | | | | | | 0.14 | 1.15 | 4.13 | 18.63 | 1.65 | 1.44 | 3.67 |
| ple 17 | | | | | | | | | | | | | | | | | | | |
| Exam- | 10.02 | | 0.25 | | | | | | 0.82 | | 0.16 | | 0.62 | 4.38 | 12.86 | 58.57 | 5.37 | 6.3 | 0.65 |
| ple 18 | | | | | | | | | | | | | | | | | | | |
| Exam- | 55.42 | | 0.48 | | | | | | 11.06 | | | | 0.02 | 1.4 | 5.17 | 22.11 | 2.08 | 2.25 | |
| ple 19 | | | | | | | | | | | | | | | | | | | |
| Exam- | 76.63 | | 0.38 | | | | | | 8.4 | | 0.79 | | | 0.09 | 0.79 | 6.02 | 0.5 | 0.3 | 6.11 |
| ple 20 | | | | | | | | | | | | | | | | | | | |
| Exam- | 74.55 | | 0.13 | | | | | | 7.81 | | 0.67 | | | 0.28 | 1.25 | 8.14 | 0.64 | 0.67 | 5.89 |
| ple 21 | | | | | | | | | | | | | | | | | | | |
| Exam- | 49.79 | | 0.42 | | | | | | | | | | 0.37 | 2.27 | 7.08 | 31.74 | 2.62 | 3.14 | 2.58 |
| ple 22 | | | | | | | | | | | | | | | | | | | |
| Exam- | 49.12 | | 0.25 | | | | | | 0.23 | | | | 0.45 | 2.25 | 7.39 | 32.43 | 2.93 | 3.17 | 1.77 |
| ple 23 | | | | | | | | | | | | | | | | | | | |

In addition, in this test, based on the measured mass concentration of each element, “the mass concentration C_{N} of the noble metal elements,” “the ratio (C_{R}/C_{N}) of the mass concentration C_{R} of the rare earth elements to the mass concentration C_{N} of the noble metal elements,” “the ratio (C₁/C_{R}) of the mass concentration C₁ of the first element to the mass concentration C_{R} of the rare earth elements,” and “the ratio (C_{Pt}/C_{N}) of the mass concentration C_{Pt} of Pt to the mass concentration C_{N} of the noble metal elements” were calculated. Respective calculation results are shown in Table 3.

### <Acid Resistance Evaluation>

A 4 wt % acetic acid aqueous solution was maintained at room temperature (23 to 25° C.), and the test piece was immersed in the acetic acid aqueous solution for 24 hours. Then, the test piece taken out from the acetic acid aqueous solution was washed with water, a scratch test was performed by rubbing zircon paper 10 times, and it was observed whether the decorative film was damaged. Then, in this test, a sample in which 30% or more of the decorative film remained was considered to have sufficient acid resistance (∘). The evaluation results are shown in Table 3.

### <Alkali Resistance Evaluation>

In this test, the test piece of each example was immersed for 30 minutes in a 0.5 wt % Na₂CO₃ aqueous solution (3 L) that was heated to 100° C. and boiled. Then, the immersed test piece was washed with water, a scratch test was performed by rubbing zircon paper 10 times, and it was observed whether the decorative film was damaged. Then, in this test, the immersion time was extended in 30 minute increments, and the maximum immersion time at which 30% or more of the decorative film remained was considered as the “endurance time (h).” Table 3 shows endurance times of respective examples.

### <Gloss Evaluation>

The gloss value of the decorative part of each example was measured using a spectrophotometer. Specifically, using a spectrophotometer (CM-700d, commercially available from Konica Minolta Japan, Inc.), the L* value, the a* value, the b* value and the gloss value indicating 8° gloss in SCI and SCE modes were measured. Then, in this evaluation, a decorative part with a gloss value of 500 or more was evaluated as having suitable gloss. Gloss values of respective examples are shown in Table 3.

TABLE 3

| | | | | | Acid | | |
|---|---|---|---|---|---|---|---|
| | Noble metal | Rare earth/ | First element/ | | resistance | Alkali resistance | |
| | concentration | Noble metal | Rare earth | Pt/Noble metal | test | test endurance time | Gloss |
| | C_{N} (%) | (C_{R}/C_{N}) | (C₁/C_{R}) | (C_{Pt}/C_{N}) | pass/fail | (h) | value |
| Example 1 | 41.89 | 0.04 | 0.00 | 0.99 | ◯ | 2 | 933 |
| Example 2 | 49.96 | 0.06 | 0.00 | 1.00 | ◯ | 1 | 1183 |
| Example 3 | 37.71 | 0.04 | 2.71 | 0.93 | ◯ | 2 | 748 |
| Example 4 | 51.68 | 0.02 | 0.00 | 0.99 | ◯ | 0.5 | 1058 |
| Example 5 | 53.01 | 0.01 | 0.00 | 0.99 | ◯ | 0.5 | 1072 |
| Example 6 | 32.93 | 0.08 | 0.05 | 1.00 | ◯ | 2 | 1167 |
| Example 7 | 53.20 | 0.03 | 0.00 | 0.78 | ◯ | 0.5 | 849 |
| Example 8 | 40.52 | 0.03 | 0.00 | 0.99 | ◯ | 1 | 997 |
| Example 9 | 30.90 | 0.15 | 0.00 | 0.99 | ◯ | 2 | 771 |
| Example 10 | 49.19 | 0.05 | 0.00 | 0.99 | ◯ | 0.5 | 1060 |
| Example 11 | 44.41 | 0.08 | 0.12 | 0.99 | ◯ | 1 | 579 |
| Example 12 | 33.53 | 0.09 | 0.06 | 1.00 | ◯ | 1.5 | 728 |
| Example 13 | 15.77 | 0.09 | 0.05 | 0.98 | ◯ | 1.5 | 970 |
| Example 14 | 15.44 | 0.09 | 0.06 | 1.00 | ◯ | 1.5 | 937 |
| Example 15 | 11.79 | 0.08 | 0.06 | 1.00 | ◯ | 1.5 | 798 |
| Example 16 | 50.99 | 0.04 | 0.00 | 0.99 | ◯ | 0.5 | 1101 |
| Example 17 | 66.91 | 0.03 | 0.00 | 0.99 | ◯ | 0.5 | 1071 |
| Example 18 | 10.27 | 0.08 | 0.20 | 0.98 | X | 1.5 | 830 |
| Example 19 | 55.90 | 0.20 | 0.00 | 0.99 | X | 2 | 537 |
| Example 20 | 77.01 | 0.11 | 0.09 | 1.00 | ◯ | 1 | 497 |
| Example 21 | 74.68 | 0.10 | 0.09 | 1.00 | ◯ | 1 | 465 |
| Example 22 | 50.21 | 0.00 | | 0.99 | ◯ | 0 | 940 |
| Example 23 | 49.37 | 0.005 | 0.00 | 0.99 | ◯ | 0 | 1001 |

As described above, in Example 1 to Example 17, decorative films having an excellent acid resistance, alkali resistance and gloss value were formed. However, in Examples 22 and 23, most of the decorative film was peeled off by simply immersing it in an alkaline solution for a short time of 30 minutes. Accordingly, it was found that, in order to secure sufficient alkali resistance of the decorative film, it was necessary to secure a certain level or more of C_{R}/C_{N}. On the other hand, in Example 19 in which C_{R}/C_{N} was too high, it was confirmed that the decorative film was easily peeled off by immersion in an acid solution. Accordingly, it was found that, since rare earth elements had an effect of lowering acid resistance of the decorative film, it was necessary to control C_{R}/C_{N} to be a certain level or less in order to obtain ceramic products having excellent overall chemical resistance. In addition, in Example 18, the acid resistance was significantly reduced even though C_{R}/C_{N} was controlled within an appropriate range. Accordingly, it was found that, in order to obtain appropriate chemical resistance (acid resistance), it was necessary to secure a certain level or more of the mass concentration C_{N} of the noble metal elements. In addition, in both Examples 25 and 26, the gloss value was significantly reduced. Accordingly, it was found that, in order to obtain ceramic products having predetermined aesthetic properties, it was necessary to control the mass concentration C_{N} of the noble metal elements to a certain level or less.

### B. Second Test

In this test, ceramic products were produced using a decorative composition having the same formulation on six types of substrates having underlying layers having different formulations (Example 24 to Example 29). Then, for the ceramic products of respective examples, in the same manner as in the first test, the acid resistance, the alkali resistance, and the gloss of the decorative film were evaluated.

### 1. Preparation of Sample

### <Production of Ceramic Product>

In Example 24 to Example 28, five types of white porcelain plates in which coat layers with different compositions were formed were prepared. In addition, in Example 29, a white porcelain plate in which a mat layer in which Zr particles were dispersed was formed on the surface was used. Then, when the decorative composition was applied to the surface of each substrate and fired, a ceramic product including a decorative film was produced. Here, the decorative composition used in this test was the decorative composition used in Example 6 in the first test. In addition, conditions for decorative composition application and the firing treatment were set to the same conditions as in the first test.

Here, in Example 24 to Example 29, since commercially available tableware was purchased, and a white porcelain plate was cut out and used, the composition of the agent (glaze, etc.) used to form the underlying layer (the coat layer or the mat layer) was unknown. Therefore, in this test, element analysis by FESEM-EDS analysis was performed on the surface of the white porcelain plate before the decorative film was formed, and the composition of the underlying layer was examined. Table 4 shows the results of the FESEM-EDS analysis.

TABLE 4

| | Under lying | | | | | | | | | | | | |
|---|---|---|---|---|---|---|---|---|---|---|---|---|---|
| | layer | Na | Mg | Al | Si | K | Ca | Zn | Ga | Sn | Ba | Ti | Zr |
| Example 24 | Coat layer | 1.12 | 4.1 | 12.25 | 65.4 | 3.93 | 9.87 | 3.32 | | | | | |
| Example 25 | Coat layer | 2.76 | 0.55 | 11.64 | 62.34 | 5.35 | 9.38 | 6.56 | | | 1.41 | | |
| Example 26 | Coat layer | 1.46 | 4.56 | 14.29 | 66.19 | 7.49 | 6.01 | | | | | | |
| Example 27 | Coat layer | 2.90 | 0.62 | 11.6 | 62.79 | 5.11 | 9.66 | 6.95 | | | | 0.37 | |
| Example 28 | Coat layer | 1.36 | 4.04 | 14.33 | 69.45 | 7.09 | 3.74 | | | | | | |
| Example 29 | Mat layer | 0.54 | | 3.02 | 25.66 | 1.82 | 0.79 | | | 35.04 | | | 33.12 |

### 2. Evaluation Test

In this test, (1) mass concentration measurement, (2) acid resistance evaluation, (3) alkali resistance evaluation, and (4) gloss evaluation were performed according to the same procedures as in the first test. Table 5 shows the measurement results of the mass concentrations, and Table 6 shows the results of acid resistance evaluation, alkali resistance evaluation, and gloss evaluation. Here, in Example 29, since a mat layer was formed to intentionally reduce the gloss of the decorative film, the gloss value decreased to an unmeasurable value. Therefore, in the gloss value column of Example 29 in Table 6, “-” indicates an unmeasurable state.

In addition, in this test, as in the first test, based on the measurement results of the mass concentrations, “the mass concentration C_{N} of the noble metal elements,” “the ratio (C_{R}/C_{N}) of the mass concentration C_{R} of the rare earth elements to the mass concentration C_{N} of the noble metal elements,” “the ratio (C₁/C_{R}) of the mass concentration C₁ of the first element to the mass concentration C_{R} of the rare earth elements,” and “the ratio (C_{Pt}/C_{N}) of the mass concentration C_{Pt} of Pt to the mass concentration C_{N} of the noble metal elements” were calculated. These calculation results are shown in Table 6.

TABLE 5

| | | | Rare earth | | | | | | | | | | | | | |
|---|---|---|---|---|---|---|---|---|---|---|---|---|---|---|---|---|
| | Noble metal element | | element | First element | | Second element | | | | | | | | | | |
| | Pt | Rh | Sm | Ti | Zr | Na | Mg | Al | Si | K | Ca | Zn | Ga | Sn | Ba | Bi |
| Example 24 | 39.44 | 0.01 | 3.47 | 0.39 | | 0.40 | 2.28 | 6.77 | 35.23 | 2.48 | 5.36 | 2.22 | | | | 1.95 |
| Example 25 | 22.61 | 0.03 | 1.53 | 0.13 | | 2.08 | 0.52 | 8.72 | 46.6 | 4.02 | 7.06 | 5.2 | | | 1.34 | 0.17 |
| Example 26 | 11.52 | | 0.55 | 0.16 | | 1.07 | 4.04 | 12.62 | 58.17 | 6.53 | 5.31 | | | | | 0.03 |
| Example 27 | 22.57 | | 1.51 | 0.47 | | 2.21 | 0.5 | 8.54 | 46.81 | 3.88 | 7.5 | 5.71 | | | | 0.31 |
| Example 28 | 38.78 | 0.17 | 2.72 | 0.26 | | 0.74 | 2.35 | 8.16 | 37.9 | 3.93 | 2.08 | | 1.25 | | | 1.68 |
| Example 29 | 50.03 | 0.18 | 4.01 | 0.29 | 9.65 | 0.73 | | 3.17 | 26.86 | 2.97 | 0.57 | | | 0.62 | | 0.92 |

TABLE 6

| | Noble metal | Rare earth/Noble | First element/Rare | | | | |
|---|---|---|---|---|---|---|---|
| | concentration C_{N} | metal | earth | Pt/Noble metal | Acid resistance | Alkali resistance test | Gloss |
| | (%) | (C_{R}/C_{N}) | (C₁/C_{R}) | (C_{Pt}/C_{N}) | test pass/fail | endurance time (h) | value |
| Example 24 | 39.45 | 0.09 | 0.11 | 1.00 | ◯ | 2 | 832 |
| Example 25 | 22.64 | 0.07 | 0.08 | 1.00 | ◯ | 0.5 | 607 |
| Example 26 | 11.52 | 0.05 | 0.29 | 1.00 | ◯ | 2 | 1102 |
| Example 27 | 22.57 | 0.07 | 0.31 | 1.00 | ◯ | 1 | 559 |
| Example 28 | 38.95 | 0.07 | 0.10 | 1.00 | ◯ | 2 | 1040 |
| Example 29 | 50.21 | 0.08 | 2.48 | 1.00 | ◯ | 0.5 | — |

As described above, in Example 24 to Example 29, the composition of the decorative film after firing was different even though the decorative composition having the same formulation was used. This is speculated to be because the decorative composition and a part of the underlying layer were mixed during the firing treatment, and constituent elements of the underlying layer were reflected in FESEM-EDS analysis. However, it was found that, in FESEM-EDS analysis of the decorative film after firing, when the mass concentration C_{N} of the noble metal elements was 11% or more and 70% or less and the ratio (C_{R}/C_{N}) of the mass concentration C_{R} of the rare earth elements to the mass concentration C_{N} of the noble metal elements was 0.01 or more and 0.18 or less, even when the decorative composition and the underlying layer were mixed, it was possible to produce a ceramic product having sufficient chemical resistance.

### C. Third Test

In this test, five types of decorative compositions having different formulations from those in the first test were prepared, and ceramic products were produced using respective decorative compositions (Example 30 to Example 34). Then, for the ceramic products of respective examples, in the same manner as in the first and second tests, the acid resistance, the alkali resistance, and the gloss of the decorative film were evaluated.

### 1. Preparation of Sample

In this test, a white porcelain plate having a coat layer (glaze) having the same composition as in the first test was prepared. Then, the decorative composition was applied to the entire surface of one side of the white porcelain plate. The decorative composition was applied using a spin coater (Opticoat MS-A-150, commercially available from Mikasa Corporation), and spin conditions were adjusted so that the film thickness of the decorative film after firing was within a range of 30 nm to 250 nm. Then, in this test, the firing treatment was performed under the same conditions as in the first test, except that the firing temperature was raised to 850° C. Thereby, the ceramic products in which the decorative film was formed on the surface were produced (Example 30 to Example 34). Here, the formulations of five types of decorative compositions used in this test are as shown in the following Table 7.

TABLE 7

| | Noble metal element | | | Rare earth element | | | | | | | First element | | Second element | | |
|---|---|---|---|---|---|---|---|---|---|---|---|---|---|---|---|
| | Pt | Au | Rh | Y | La | Ce | Pr | Nd | Sm | Dy | Ti | Co | Al | Si | Bi |
| Example 30 | 83.24 | | 0.46 | | | | | | 7.84 | | 0.71 | | 0.14 | 6.42 | 1.18 |
| Example 31 | 84.24 | | 0.47 | | | | | | 7.93 | | 0.72 | | 0.14 | 6.50 | |
| Example 32 | 78.79 | | 1.35 | | | | | | 7.42 | | 0.69 | | 0.13 | 6.08 | 5.54 |
| Example 33 | 81.06 | | 1.34 | | | | | | 7.63 | | 0.69 | | 0.14 | 6.25 | 2.88 |
| Example 34 | 82.48 | | 1.37 | | | | | | 7.77 | | 0.71 | | 0.14 | 6.36 | 1.17 |

### 2. Evaluation Test

In this test, (1) mass concentration measurement, (2) acid resistance evaluation, (3) alkali resistance evaluation, and (4) gloss evaluation were performed according to the same procedures as in the first and second tests. Table 8 shows the measurement results of the mass concentrations, and Table 9 shows the results of acid resistance evaluation, alkali resistance evaluation, and gloss evaluation.

In addition, in this test, as in the first and second tests, based on the measurement results of the mass concentrations, “the mass concentration C_{N} of the noble metal elements,” “the ratio (C_{R}/C_{N}) of the mass concentration C_{R} of the rare earth elements to the mass concentration C_{N} of the noble metal elements,” “the ratio (C₁/C_{R}) of the mass concentration C₁ of the first element to the mass concentration C_{R} of the rare earth elements,” and “the ratio (C_{Pt}/C_{N}) of the mass concentration C_{Pt} of Pt to the mass concentration C_{N} of the noble metal elements” were calculated. These calculation results are shown in Table 9.

TABLE 8

| | Noble metal element | | | Rare earth element | | | | | | | First element | | Second element | | | | | | |
|---|---|---|---|---|---|---|---|---|---|---|---|---|---|---|---|---|---|---|---|
| | Pt | Au | Rh | Y | La | Ce | Pr | Nd | Sm | Dy | Ti | Co | Na | Mg | Al | Si | K | Ca | Bi |
| Example 30 | 43.43 | | 0.19 | | | | | | 3.76 | | 0.2 | | 0.42 | 2.61 | 7.4 | 35.7 | 3.19 | 3.09 | |
| Example 31 | 30.25 | | 0.32 | | | | | | 2.3 | | 0.3 | | 0.60 | 2.64 | 9.86 | 45.78 | 4.48 | 3.46 | |
| Example 32 | 46.4 | | 0.66 | | | | | | 3.84 | | 0.38 | | 0.40 | 1.87 | 6.85 | 33.24 | 3.26 | 3.09 | |
| Example 33 | 44.1 | | 0.57 | | | | | | 3.65 | | 0.32 | | 0.50 | 2.86 | 7.69 | 33.95 | 3.01 | 3.36 | |
| Example 34 | 45.86 | | 0.76 | | | | | | 3.85 | | 0.33 | | 0.27 | 2.39 | 7.21 | 33.35 | 3.09 | 2.89 | |

TABLE 9

| | Noble metal | Rare earth/ | First element/Rare | | | Alkali resistance | |
|---|---|---|---|---|---|---|---|
| | concentration C_{N} | Noble metal | earth | Pt/Noble metal | Acid resistance | test | |
| | (%) | (C_{R}/C_{N}) | (C₁/C_{R}) | (C_{Pt}/CN) | test pass/fail | endurance time (h) | Gloss value |
| Example 30 | 43.62 | 0.09 | 5.32 | 0.996 | ◯ | 1.5 | 1020 |
| Example 31 | 30.57 | 0.08 | 13.04 | 0.990 | ◯ | 1.5 | 970 |
| Example 32 | 47.06 | 0.08 | 9.90 | 0.986 | ◯ | 1.5 | 918 |
| Example 33 | 44.67 | 0.08 | 8.77 | 0.987 | ◯ | 1.5 | 933 |

As shown in Table 8, in this test, not only in Example 31 (refer to Table 7) in which bismuth (Bi) was not added to the decorative composition but also in all of Example 30 to Example 34, the presence of bismuth (Bi) was not confirmed in the decorative film. This is speculated to be because, when the firing temperature was raised, diffusion of Bi elements during firing was accelerated, and as a result, the Bi concentration was equal to or lower than the detection limit. On the other hand, in all of Example 30 to Example 34, decorative films having an excellent acid resistance, alkali resistance and gloss value were formed. Accordingly, it was found that, when the mass concentration C_{N} of the noble metal elements was within a range of 11% or more and 70% or less, and C_{R}/C_{N} was within a range of 0.01 or more and 0.18 or less, even if the Bi element had a very low concentration equal to or lower than the detection limit, a decorative film having excellent chemical resistance and aesthetic properties could be formed.

While specific examples of the technology disclosed here have been described above in detail, these are examples, and do not limit the scope of the claims. The technologies described in the scope of the claims include various modifications and alternations of the specific examples exemplified above.

### REFERENCE SIGNS LIST

1 Ceramic product
10 Substrate
20 Coat layer
30 Decorative film
32 Noble metal region
34 Amorphous region

1. A ceramic product including a decorative film containing noble metal elements and matrix-forming elements,
wherein the matrix-forming elements include at least a rare earth element,
wherein the mass concentration C_{N} of the noble metal elements obtained in FESEM-EDS analysis of the surface of the decorative film is 11% or more and 70% or less, and
wherein the ratio (C_{R}/C_{N}) of the mass concentration C_{R} of the rare earth elements to the mass concentration C_{N} of the noble metal elements is 0.01 or more and 0.18 or less.

2. The ceramic product according to claim 1, wherein the matrix-forming elements further include at least one of first elements including Zr, Ti and Co.

3. The ceramic product according to claim 2,
wherein the ratio (C1/CR) of the mass concentration C1 of the first element to the mass concentration CR of the rare earth elements obtained in FESEM-EDS analysis of the surface of the decorative film is 3 or less.

4. The ceramic product according to claim 1,
wherein the decorative film contains at least one selected from the group consisting of Pt, Au, Pd, Rh, Ir, and Ag as the noble metal elements.

5. The ceramic product according to claim 4,
wherein the ratio (C_{Pt}/C_{N}) of the Pt mass concentration C_{Pt} to the mass concentration C_{N} of the noble metal elements is 0.75 or more.

6. The ceramic product according to claim 1,
wherein the decorative film contains at least one selected from the group consisting of Y, Sm, La, Ce, Pr, Nd, and Dy as the rare earth elements.

7. The ceramic product according to claim 1,
wherein the matrix-forming elements further include at least one of second elements including Si, Al, K, Na, Mg, Ca, Ga, Ba and Bi.

8. The ceramic product according to claim 1,
wherein the decorative film includes a noble metal region containing the noble metal element as a main component and an amorphous region containing the matrix-forming element as a main component, and a plurality of the noble metal regions are scattered in the amorphous region.
